(19) United States
(12) Patent Application Publication
(10) Pub. No.: US 2014/0351453 A1
(43) Pub. Date: Nov. 27, 2014

(54) Node in a Network

(71) Applicants: Koninklijke KPN N.V., The Hague (NL); Nederlandse Organisatie voor Toegepast-Natuurweten schappelijk Onderzoek TNO, Delft (NL)

(72) Inventors: Hans Maarten Stokking, Wateringen (NL); Frank Den Hartog, Voorschoten (NL); Manuel Herrera Van Der Nood, Hellevoetsluis (NL); Bernardus Hillen, Zoetermeer (NL); Harm Mulder, Katwijk (NL)

(73) Assignees: KONINKLIJKE KPN N.V., The Hague (NL); Nederlandse Organisatie voor Toegepast-Natuurweten schappelijk Onderzoek TNO, Delft (NL)

(21) Appl. No.: 14/364,806

(22) PCT Filed: Dec. 13, 2012
(86) PCT No.: PCT/EP2012/075404

§ 371 Date: Jun. 12, 2014

(30) Foreign Application Priority Data
Dec. 14, 2011 (EP) 11193401.4

(51) Int. Cl. H04L 29/12

(52) U.S. Cl. CPC H04L 61/256
USPC 709/245

(57) ABSTRACT

The invention relates to a network node for facilitating traversal of NATs. The node includes a NAT, a client such as e.g. a STUN client, configured for determining NAT-related information for the NAT by exchanging one or more messages with a server such as e.g. a STUN server, and a routing unit configured for routing the messages exchanged between the client and the server via the NAT. Implementing the client on such a network node allows messages sent by a NAT information provider, NIP, to reach the client, while implementing the routing unit ensures that the client is “behind” the NAT in the network sense. In this manner, the NIP may request NAT behaviour discovery and obtain NAT-related information from the client and is able to later provide appropriate NAT-related information to terminals in local networks, thereby enabling the terminals to traverse the NATs that they are behind.

### FIELD OF THE INVENTION

Generally, the invention relates to the field of data communication. More specifically, the invention relates to the field of NAT traversal.

### BACKGROUND OF THE INVENTION

Network Address Translators (NATs) have been devised to alleviate IPv4 address exhaustion by allowing the use of private Internet Protocol (IP) addresses for devices in internal, local networks (e.g. in home and corporate networks) placed behind routers with a single public IP address presented to an external network such as the Internet. A NAT allows the End User Devices (EUDs) in a local network to communicate with devices in an external network by changing the source address of outgoing requests to that of the NAT in the local network and then relaying incoming replies back to the originating EUD. This means that communication across a NAT is possible only when initiated by a device belonging to the local network. As a result, services that require establishment of a connection initiated by a device from the external network (such as e.g. peer-to-peer (P2P) file sharing, Voice over IP (VoIP) services, or the online services of video game consoles) fail unless special measures to avoid this failure are taken. Such special measures in the prior art include Universal Plug and Play (UPnP), Session Border Controllers (SBCs), and Interactive Connectivity Establishment (ICE).

Many of the present NAT traversal techniques require the determination of some type of information regarding the NAT and its behavior, a process that could be referred to as “behavior discovery.” Typically, the so-called STUN protocol is used for this purpose, in which a communications application, referred to as a “STUN Client,” on an EUD behind a NAT exchanges a number of messages with a STUN server in an external network in order to determine behavior of the NAT. The use of the STUN Server is described in IETF RFC 5389 and possible behavior discovery is described also in IETF RFC 5780.

In the majority of current solutions, determination of the relevant NAT information is performed immediately before the information is used, for example during a VoIP call setup in which the information is requested with the result that a determination is immediately made. This, however, creates a number of further problems. One problem is that discovery of NAT-related information, particularly the detailed investigation of NAT behavior, requires a lot of messages to be exchanged over the network, which adds load both on the local and external network and on the STUN server assisting with NAT behavior determination. Another problem is that NAT behavior discovery takes time and where more detailed information is needed it takes correspondingly longer to discover. This means that the waiting time before the connection can be set up could be quite long.

WO 2009/018004 proposes a solution for decreasing the amount of time and the amount of messages exchanged in determining NAT behaviour. The solution includes EUDs in a local network sharing information about discovered behaviour of the NAT in their local network. In addition, the EUDs can actively cooperate to further determine behaviour of the NAT in their network, rather than passively share NAT behaviour that they discovered independent of one another. The NAT information regarding that NAT is then stored in a central location that all EUDs behind that NAT are able to access.

### SUMMARY OF THE INVENTION

It is an object of the invention to provide improved methods and systems for NAT traversal.

According to one aspect of the present invention, a network node is provided. The network node includes a NAT unit implementing NAT's functionality, a client such as e.g. a STUN client, configured for determining NAT-related information for the NAT by exchanging one or more messages with a server such as e.g. a STUN server, and a routing unit configured for routing the messages exchanged between the client and the server via the NAT unit. The network node could be, for example, a NAT, a home gateway, a router, or a home gateway comprising a router.

The invention is based on the recognition that implementing the client on a network node having NAT functionality, as opposed to implementing the client on a terminal in a local network behind such network node, eliminates the need to have a terminal behind the NAT that is available for NAT behaviour discovery, while the routing unit ensures that the client is behind the NAT in the network sense. With such implementation, when the network node having NAT functionality is available, meaning that the network node is “online,” switched on and connected, testing of the NAT may be immediately carried out where the NIP would request NAT behaviour discovery and obtain NAT-related information from the client. In addition, implementing the client on the network node allows messages sent by a NAT information provider, or NIP, to reach the client. After that, the NIP is able to provide appropriate NAT-related information to terminals in local networks, the provided NAT-related information enabling the terminals to traverse the NATs that they are behind.

As used herein, the phrase “a terminal traversing a NAT” and variations thereof are used to describe enabling one or more software applications on the terminal behind the NAT to receive data traffic from applications or clients in the external network, in other words enabling the data traffic from one or more applications or clients in the external network to reach the one or more application or clients behind the NAT. Also in other words, the phrase “traversing a NAT” is used in a general sense, meaning enabling communication between a terminal behind the NAT and a device in the external network. This communication is two-way, not only allowing traffic from the inside to go outside the NAT, but also to have traffic coming from outside go to the terminal inside the NAT.

As used herein, the term “terminal” refers to any end user device or computing system within a local network. The terminal could include, but is not limited to, e.g. a computer, a hand-held internet browser, an email device, a VoIP phone, a game console, or a hand-held gaming device.

Further, as used herein, the term “NAT-related information” refers to any information that allows traversing the NAT at some point. A person skilled in the art would understand that such information could include, but is not limited to, e.g. one or more of current ports in use by the NAT, current WAN IP address of the NAT, current virtual server rules implemented in the NAT, port mapping behaviour and filtering behaviour of the NAT, support for hairpinning, one or more of port allocation algorithms used by the NAT, timeout value for NAT binding, behaviour of the NAT during congestion, during heavy network traffic, during large number of simultaneous sessions and/or during multiple simultaneous NAT bindings.

According to another aspect of the present invention, a NAT-information server functionality referred to herein as a “NAT information provider” or “NIP”, for use with the above described network node is also provided. The NIP is configured at least for receiving from the network node the NAT-related information and storing the NAT-related information in a database, where the NAT-related information is stored associated with an identification of a NAT type of the NAT unit included in the network node. In this manner, the NIP may obtain and maintain a database storing NAT-related information for NATs of different NAT types. The NIP may then be configured to provide NAT-related information for NATs of a particular NAT type to a terminal in a local network, the local network including a NAT of that NAT type, where the NAT-related information provided to the terminal enables the terminal to traverse the first NAT.

The functionality of such NIP is based on the recognition that NAT-related information obtained by testing a NAT of a specific NAT type (e.g. a specific brand, model, and/or firmware version of a NAT) may be re-used for other NATs of the same type, irrespective of the local network in which those NATs are used. In other words, a NAT of a specific NAT type may be tested once and the NAT-related information obtained as a result of the testing may be re-used for any situation in which a NAT of this specific type is deployed, thus alleviating the need to separately test the NATs of the same type in each local network that contains these NATs. In this manner, unlike in the technique described in WO 2009/018004, situations may be envisioned where none of the terminals behind a particular NAT of this type need to carry out any NAT testing in order to obtain the necessary NAT-related information. The proposed NIP allows decreasing the load on the network and on the STUN Server participating in the NAT behaviour discovery process as the complicated NAT discovery process does not need to be carried out by each individual terminal in each local network or even by one terminal within a local network deploying a NAT of a particular NAT type. Of course, some embodiments are envisioned and are within the scope of the present invention where the terminals behind the NATs of a particular type still need to carry out some additional testing, e.g. to complement the NAT-related information obtained from the network node. However, the advantages described above are still significant even for such embodiments. In an embodiment of the invention, the testing of the NAT may be performed with STUN server functionality being implemented on the NAT. Possibly the STUN client functionality can also be implemented on the NAT. The STUN server in this embodiment of the invention is implemented in such a way on the NAT that the messages, for example STUN messages, which are for example used for the testing of the NAT behaviour of the NAT, are routed through the address translation part of the NAT. The client referenced to here or above can be implemented in the local network or the network node.

Further, storing the NAT-related information in a database on a per-type basis at least for some NAT types provides the advantage of saving server storage space, as opposed to storing the NAT-related information on a per-device basis for the NAT devices of those NAT types.

In the context of the embodiments of the present invention two NATs are referred to as “being of the same NAT type” if they behave substantially the same in most practically feasible circumstances. This usually means they are the same brand, model and firmware, but it may also mean that they are just the same brand, if all NAT devices of that brand have substantially the same behaviour.

According to other aspects of the present invention, the present disclosure relates to a computer program with portions, possibly distributed, for performing the various functions described herein and to a data carrier for such software portions.

Hereinafter, embodiments of the invention will be described in further detail. It should be appreciated, however, that these embodiments may not be construed as limiting the scope of protection for the present invention.

### BRIEF DESCRIPTION OF THE DRAWINGS

In the drawings:

FIG. 1 is a schematic illustration of a computing environment with a NIP providing NAT-related information to one or more EUDs, according to one embodiment of the present invention;

FIG. 2 is a schematic illustration of how the environment illustrated in FIG. 1 could be implemented in practice, according to one embodiment of the present invention;

FIG. 3 sets forth a flow diagram of method steps of TR-069 sequence of NIP management of an EUD, according to one embodiment of the present invention;

FIG. 4 is a schematic illustration of an example of performing the method of FIG. 3 using RPC, according to one embodiment of the present invention;

FIG. 5 provides an example of a possible CWMP SetParameterValues request, according to one embodiment of the present invention;

FIGS. 6A-6C illustrate how a NAT-type identifier identifying the type of a NAT that an EUD is behind can be provided to the NIP, according to various embodiments of the present invention.

FIG. 7 is a schematic illustration of an exemplary setting in which a NIP could provide NAT-related information to an EUD, according to one embodiment of the invention;

FIGS. 8A and 8B set forth flow diagrams of method steps of a NIP collecting NAT-related information, according to different embodiments of the present invention;

FIG. 9 is a schematic illustration of the interaction between a NIP, a STUN client, and a STUN server, according to one embodiment of the present invention;

FIGS. 10 and 11 provide schematic illustrations of different manners for deploying a STUN client, according to various embodiments of the present invention;

FIG. 12A provides yet another manner for deploying a STUN client, according to one embodiment of the present invention;

FIG. 12B provides a schematic illustration of a NAT capable of implementing STUN client functionality as shown in FIG. 12A, according to one embodiment of the present invention;

FIG. 13A provides a schematic illustration of deploying a STUN server as a part of a NAT, according to one embodiment of the present invention;

FIG. 13B provides a schematic illustration of a NAT capable of implementing STUN server functionality as shown in FIG. 13A, according to one embodiment of the present invention;

FIG. 14A provides a schematic illustration of deploying both a STUN client and a STUN server as part of a NAT, according to one embodiment of the present invention; and

FIG. 14B provides a schematic illustration of a NAT capable of implementing STUN client and STUN server functionalities as shown in FIG. 14A, according to one embodiment of the present invention.

### DETAILED DESCRIPTION OF THE DRAWINGS

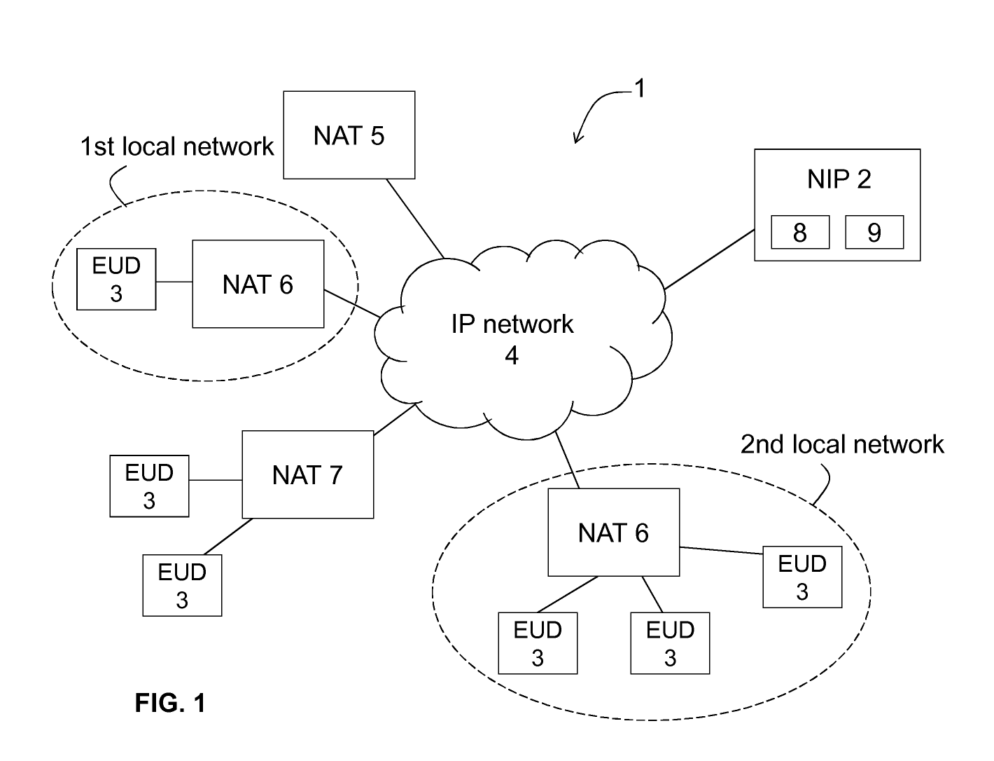

FIG. 1 is a schematic illustration of a computing environment 1 with a NIP 2 providing NAT-related information to one or more EUDs 3, according to one embodiment of the present invention. In the context of the present invention, the term “EUD” is used to describe a “terminal” as defined above. As shown, the NIP 2 may be connected, via an IP network 4, to a number of NATs 5-7. Each of the NATs may connect one or more EUDs 3 present in a local area network (LAN) behind the respective NAT to the IP network 4, as is shown for NATs 6 and 7. Of course, a LAN behind a NAT may also be empty of EUDs, as is shown for NAT 5.

The different NATs 5-7 may be of the same type, but may also be of different types. The different numerals (5, 6, and 7) assigned to the NATs in FIG. 1 are intended to illustrate, in an exemplary embodiment, that the NAT 5 may be a NAT of one NAT type, the two NATs 6 may be NATs of another NAT type, while the NAT 7 may be a NAT of a third NAT type.

Note that two or more elements illustrated in FIG. 1 with the same reference numerals, such as e.g. two NATs 6 and multiple EUDs 3 are not intended to indicate that elements with each one of those reference numerals are the one and only device, but, rather to indicate that each of them is a different one of those devices. Thus, FIG. 1 illustrates multiple implementations of the same terminal, i.e. the EUD 3, and multiple implementations of a NAT of the same NAT type, i.e. the NAT 6.

The NIP 2 is configured to provide NAT-related information for particular NAT types to any one or more of the EUDs 3 and/or the NATs 5-7 themselves, once the NIP 2 obtains an identification of the particular type of NAT for which the NAT-related information is required. To that end, the NIP 2 may include at least a database 8 containing NAT-related information for different NAT types, where the NAT-related information for the different NAT types is stored in such a manner that it can be retrieved based on the identification of a particular NAT type (NAT-type ID). The NIP 2 may further include a processor 9 for processing the NAT-related information. The NIP 2 may also include a communication module (not shown in FIG. 1) for sending and receiving messages/data to other devices.

The NAT-related information that can be provided by the NIP 2 for a particular NAT type includes information that enables a terminal in a local network behind a NAT of that type to traverse that NAT, i.e. the NAT-related information provided by the NIP 2 enables one or more clients on the terminal behind the NAT to receive data traffic from one or more clients in the external network.

The NIP 2 providing the NAT-related information to the terminals on a per-type basis, as opposed to a per-device basis, allows re-using NAT-related information obtained by testing one or more NATs of a specific NAT type (e.g. a specific brand, model, and/or firmware version of a NAT) for other NATs of the same type, irrespective of the local network in which those NATs are used. In other words, a specific NAT type may be tested once and the NAT-related information obtained as a result of the testing may be re-used for any situation in which a NAT of this type is deployed, thus alleviating the need to separately test the NATs of the same type in each local network that contains these NATs. For the exemplary scenario illustrated in FIG. 1, this means that NIP 2 may provide the same NAT-related information to the one EUD 3 behind the first NAT 6 in a first local network and to one or more of the three EUDs 3 behind the second NAT 6 in a second local network, the local networks illustrated in FIG. 1 with dashed lines. Such re-using of NAT-related information is possible because these NATs 6 are NAT devices of the same NAT type, e.g. NATs of the same brand, model and firmware.

Note that FIG. 1 illustrates each of the NATs 5-7 as being included within a respective local network and the discussions provided herein are tailored to the typical use of NATs, i.e. the situation of a NAT connecting a local area network to an external or wide area network. However, one skilled in the art will appreciate that the ideas provided herein will also work in and can be adapted to other implementations of NATs, such as the provider-NAT, i.e. the situation where a provider implements the NAT in the network and assigns private addresses to user equipment. In such implementations, the NATs would not necessarily be included in local networks. Also, while the typical NAT problem is for IPv4 NAT traversal, embodiments of the present invention are also applicable to other forms of NAT, such as IPv4/IPv6 NAT or inter-provider NAT, i.e. NAT applied by a network provider in the interconnection to other network providers.

In various embodiments, the NAT-related information for each of the different NAT types may include e.g. one or more of current ports in use, current WAN IP address or addresses, current virtual server rules, port mapping behaviour, filtering behaviour, support for hairpinning, one or more of port allocation algorithms, timeout value for NAT bindings, behaviour during congestion, behaviour during heavy network traffic, behaviour during large number of simultaneous sessions and/or multiple simultaneous NAT bindings. Of course, other kinds of NAT-related information that could be used for facilitating NAT traversal can be envisaged and are within the scope of the present invention.

Some of the NAT-related information described above may appear to be device-specific as opposed to being type-specific. In other words, some of the NAT-related information described above may appear to be specific for a particular NAT as opposed to being characteristic to all of the different NATs of a particular NAT type. Some examples of such information include current ports in use or virtual server rules. However, it turns out that, surprisingly, such information may actually be typical for all implementations of a certain type of NATs and, thus, may be considered type-specific.

In various embodiments, the NIP 2 could further be configured to not only provide NAT-related information for certain NAT types, but also provide specific information for particular NATs. The NIP 2 may also be configured to combine providing generic NAT-related information for NATs of a certain NAT type with providing specific information on a specific NAT.

In the context of the present invention, two NATs are referred to as “being of the same NAT type” if they behave substantially the same in most or all practically feasible circumstances. This usually means they are the same brand, model and firmware, but it may also mean that they are just the same brand, if all NAT devices of that brand have substantially the same behaviour. In various embodiments, an identification of a particular NAT type (i.e., the NAT-type ID) may include information indicative of one or more of e.g. the NAT's vendors Organizational Unique Identifier (OUI), the vendor's or manufacturer's name, the model number, the model name, the hardware version, the software version, the boot rom version, the NAT device serial number, the vendors enterprise number, and the vendors class data. However, the NAT-type ID does not necessarily have to be an actual ID as one of the examples described above, but could be any information that enables the NIP 2 to determine the NAT-type ID, such as e.g. a public IP address of the NAT included in the request for NAT-related information received by the NIP 2, if the NIP 2 knows which NAT has this IP address. Thus, various other ways to enable the NIP 2 to identify a particular NAT type may be envisioned and are within the scope of the present invention.

It should be noted, that, unlike with the technique proposed by WO 2009/018004 described above, according to embodiments of the present invention, using a Media Access Control (MAC) address as an identifier of a NAT type would typically not be sufficient on its own. This would be sufficient if NAT-related information was available in the NIP 2 on a per-device basis, because MAC addresses are unique worldwide. According to the embodiments of the present invention, however, at least for the NATs of some NAT types, the database 8 of the NIP 2 contains NAT-related information on a per-type basis. Since, although a MAC address does identify the vendor of the NAT, it does not identify the specific product type, using the MAC address as a NAT-type identifier on it's own would not be sufficient when using the database 8. The MAC address can still be used for identifying the device type, but in that case the database 8 would need to contain a list of MAC addresses or MAC address ranges and device types. In some implementations, such as e.g. home gateways supplied by an internet service provider, a list of this kind may be available, because such providers often keep track of this information for other purposes, such as e.g. for gateway authentication in the network. Also, device manufacturers could supply this information through some offline process.

Similar to using the MAC address, the Wide Area Network (WAN) IP address of a NAT may also be used as a unique identifier at a certain point in time. When WAN IP addresses are e.g. assigned using DHCP, this IP address is linked to the MAC address at that time, and thus to a specific de-device at that time.

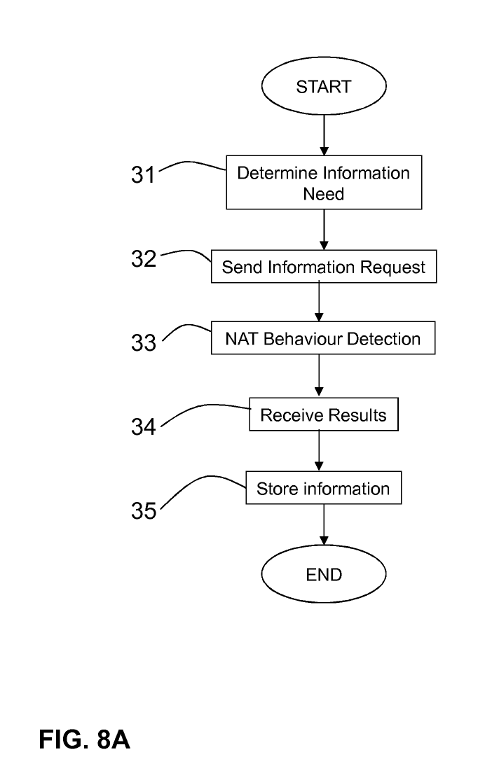

How the NIP 2 may obtain and maintain the database 8 is described in greater detail in association with FIGS. 8A-14B.

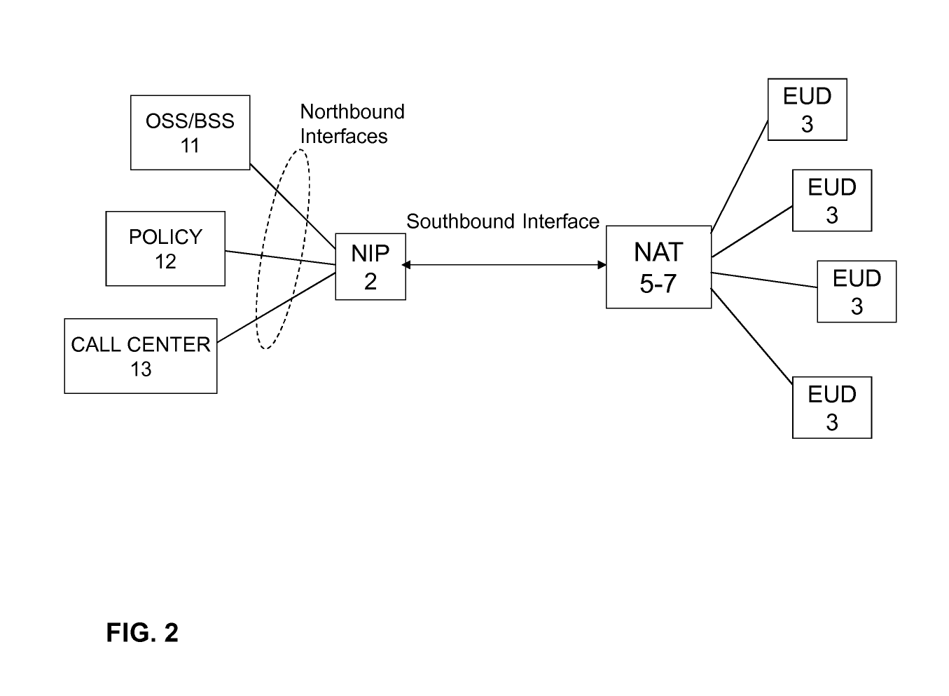

FIG. 2 is a schematic illustration of how the environment 1 illustrated in FIG. 1 could be implemented in practice, according to one embodiment of the present invention. To that end, FIG. 2 illustrates a typical set up for remote device management following TR-069 specifications of the Broadband Forum. A NAT shown in FIG. 2 could be one of the NATs 5-7 illustrated in FIG. 1 and could include or be included within a managed internet gateway device (managed IGD) such as e.g. a home gateway (HG). In the present description, notation “NAT 5-7” is used to indicate a NAT that could be either the NAT 5, the NAT 6 or the NAT 7, illustrated and described in FIG. 1.

As shown in FIG. 2, the NAT 5-7 is connected, on its WAN interface, to the NIP 2. The NIP 2 could be implemented as part of an Auto-Configuration Server (ACS). On the right side of FIG. 2, a typical LAN is shown, comprising the NAT 5-7 and various EUDs 3, such as a phone, a set-top box (STB), a tablet or a PC.

The NIP 2 is capable of performing remote management of the various EUDs 3 in a LAN, or, in other words, is capable of providing NAT-related information to the various EUDs 3 and/or configuring the EUDs in accordance with the provided NAT-related information. To that end, the NIP 2 has a Southbound interface and may have a number of Northbound interfaces, as shown in FIG. 2. The management may be done via the NIP's, IP-based, Southbound Interface using e.g. the CPE WAN Management Protocol (CWMP). In a typical setup, the NIP 2 would be connected somewhere in the IP Core Network of an Internet Service Provider (ISP). The NAT 5-7 may then be connected via the edge and access network to this IP Core Network. In this manner the NAT 5-7 would have an IP connection to the NIP 2. The Northbound Interface connects the NIP 2 to an OSS/BSS 11 and a Policy Center 12, for performing e.g. order fulfilment, billing, subscriber management, policy management, change management, manufacturing management, performance analytics, or service level agreement management. The Northbound Interface also connects the NIP 2 to a Call Center 13 for e.g. receiving configuration, installation and for use by Call Center employees.

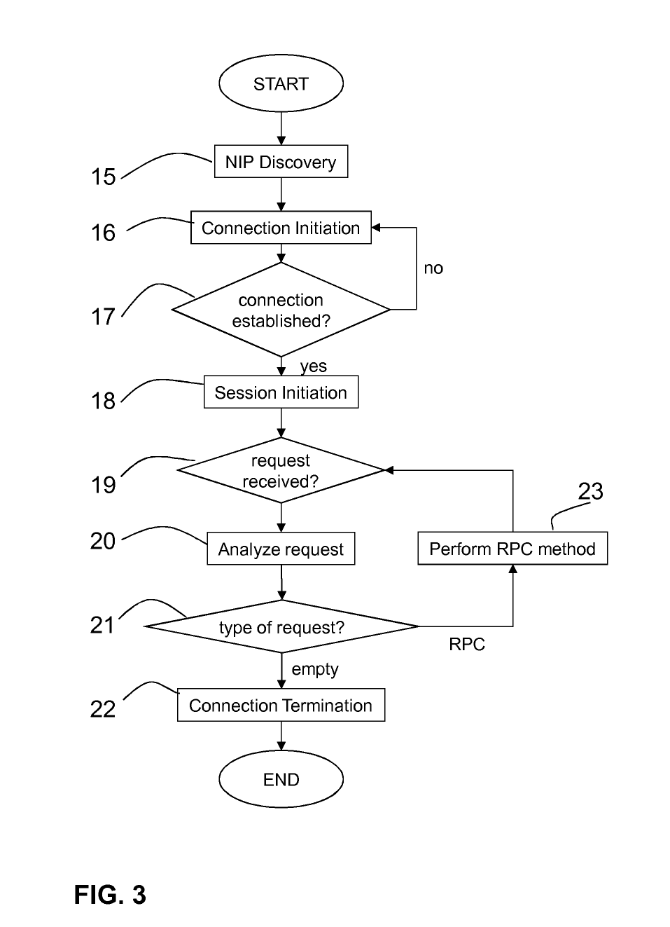

FIG. 3 sets forth a flow diagram of method steps of TR-069 sequence of NIP management of an EUD, according to one embodiment of the present invention. While the method steps are described in conjunction with FIGS. 1 and 2, persons skilled in the art will recognize that any system configured to perform the method steps, in any order, is within the scope of the present invention.

The method begins with step 15, where the EUD 3 initiates a NIP discovery procedure to discover the NIP 2. To that end, in one embodiment in accordance with TR-069, the URL of the NIP 2 could be pre-configured in the EUD 3. In another embodiment, the EUD 3 could receive the URL of the NIP 2 as a DHCP-option from the IGD. TR-069 provides other options as well that are within the scope of the present invention. One such option is that the EUD 3 would not be configured with the address of the NIP 2, but with the address of an intermediate entity, such as e.g. some intermediate network node. This intermediate entity can then forward or proxy requests from the EUD 3 to the NIP 2. Such a setup can be done for scalability purposes, or to route requests to different NIPs, e.g. depending on the type of request that is made.

After the NIP 2 is discovered by the EUD 3, in step 16, the EUD 3 may set up a Trans-mission Control Protocol (TCP) connection to the NIP 2. This may be done by exchanging TCP syn packets and TCP ack packets, as specified in IETF RFC 793 on TCP. If connection setup fails for some reason, the EUD 3 may retry connection initiation until successful, as shown with step 17.

After initiating the connection, in step 18, the EUD 3 initiates setting up of a transaction session by sending an CWMP Inform Request to the NIP 2 and receiving an CWMP Inform Response and then sending an empty HTTP Post to the NIP 2. After this session has been established, the EUD 3 can receive requests from the NIP 2. If the EUD 3 receives a request (step 19), then the EUD 3 analyses the request (step 20). As a result of the analysis, the EUD 3 determines the type of the request (step 21), i.e., determines whether the request contains an empty HTTP Post or a remote procedure call (RPC). An empty HTTP Post is a sign that the session can be terminated, as illustrated with step 22. If, however, in step 21, the EUD determines that the request contains actual instructions in the form of RPC, then the EUD 3 may proceed to perform RPC method in accordance with the instructions (step 23).

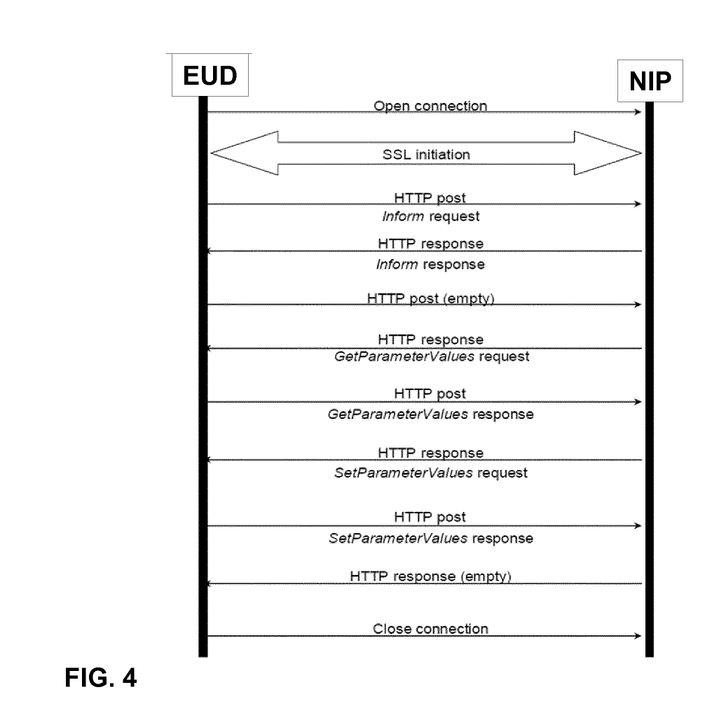

One example of a request received by the EUD 3 in step 19 can be a CWMP GetParameterValues request. With such a request the NIP 2 would, after the session is established in step 18, request a listing of the parameters that are present in the EUD 3. Since this request is not an empty HTTP Post, the EUD 3 would send a CWMP GetParameterValues response, as a part of step 23. After this, the NIP 2 would know which parameters are present in the EUD 3, and could then set the value of these using a CWMP SetParameterValues request which the EUD 3 would receive in step 19. Thus, the CWMP SetParameterValues request can be used by the NIP 2 to instruct the EUD to configure NAT behaviour parameters (i.e. provide the NAT-related information for a particular NAT type of a NAT that the EUD is behind, where the provided information allows configuring the EUD to be able to traverse the NAT), as a part of step 23 following receipt of the CWMP SetParameterValues request. The flow of these steps is shown in FIG. 4. The flow of steps in FIG. 4 is illustrated, as a person skilled in the art would understand, in a chronological order from the top to the bottom of FIG. 4 and follows the same sequence of method steps as shown in FIG. 3, but is a concrete example of the use of the RPC methods GetParameterValues and SetParameterValues.

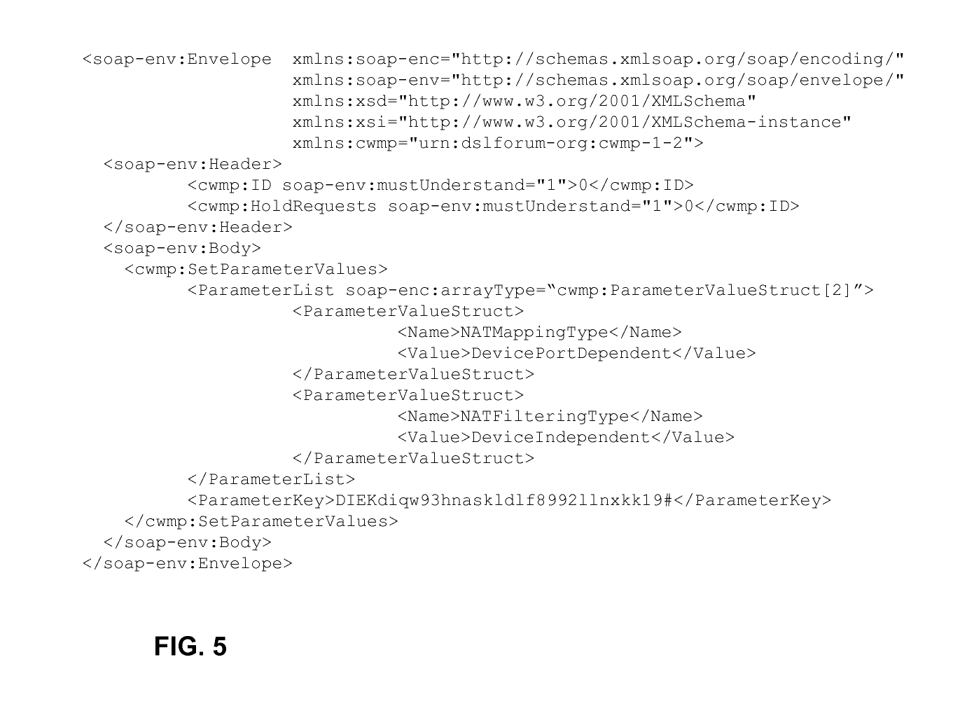

FIG. 5 provides an example of a possible CWMP SetParameterValues request, as the one that could be sent by the NIP 2 to the EUD 3, according to one embodiment of the present invention. CWMP uses SOAP as an envelope and HTTP as an application layer protocol, on top of TCP as transport protocol. The SetParameterValues request is thus a typical SOAP request, in this case an SOAP request conforming to the XML schemes as specified in TR-069. While the parameters NATMappingType and NATFilteringType are not specified by TR-069, they are included in FIG. 5 as an example of how the CWMP SetParameterValues request would work using TR-069, if TR-069 was adapted to contain support for NAT behaviour description parameters. This particular CWMP SetParameterValues request would instruct the EUD 3 to set two parameters to new values. The parameter NATMappingType would be set to DevicePortDependent and the parameter NATFilteringType would be set to DeviceIndependent.

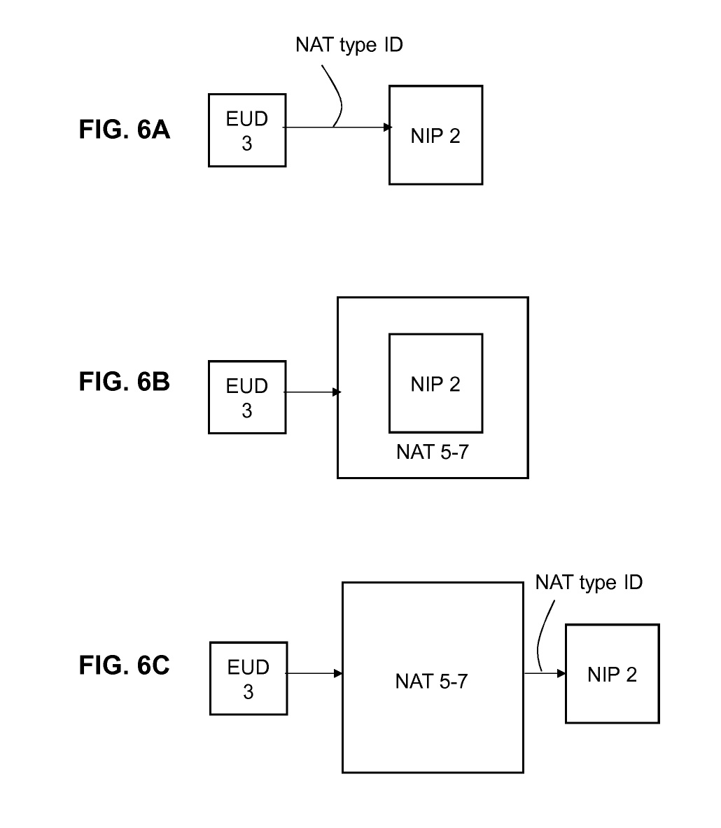

FIGS. 2-5 illustrate how an EUD can request NAT-related information from a NIP on the particular type of NAT that the EUD is behind. To this end, the NIP needs to know the identity of this NAT. This identity may be discovered in different ways, and may be provided to the NIP in different ways. FIGS. 6A-6C illustrate how a NAT-type identifier (NAT-type ID) identifying the type of a NAT that the EUD 3 is behind can be provided to the NIP 2, according to various embodiments of the present invention.

As shown in FIG. 6A, according to one embodiment, the EUD 3 can itself provide to the NIP 2 the NAT-type ID. The EUD 3 can have access to the NAT-type ID through various means allowing the unique identification of a specific NAT type, such as e.g. the use of DHCP vendor identifying DHCP-options from IETF RFC 1925, the use of UPnP device description, or the use of the TR-069 specifications on Device-Gateway Association. In such an embodiment, the EUD 3 would provide the NAT-type ID to the NIP 2, possibly as a part of a request for NAT-related information for NATs of the type identified by the NAT-type ID or as a part of a general configuration request.

As shown in FIG. 6B, according to another embodiment, the NIP 2 could be a part of the NAT 5-7 and, as a result, know the identity of the NAT type of the NAT 5-7. In such an embodiment, the EUD 3 would send a request for NAT-related information to the NAT 5-7 containing the NIP 2.

As shown in FIG. 6C, according to yet another embodiment, a request from the EUD 3 for NAT-related information could go through the NAT 5-7 to get to the NIP 2. In such an embodiment, the NIP 2 may learn the NAT-type ID either because the NAT 5-7 attaches the NAT-type ID to the request sent from the EUD 3 or because the NIP 2 can recognize the NAT-type ID from the request received, for example based on the public IP address of the NAT 5-7, if the NIP 2 knows which NAT has this IP address.

In one embodiment of FIG. 6C, the EUD 3 may not be configured with the address of the NIP 2. Instead, the address of the NIP 2 may be configured in the NAT 5-7. The EUD 3 may then send its requests to the NAT 5-7 and the NAT 5-7 may then serve as a proxy for the requests, forwarding the requests to the NIP 2.

The discussions provided for the embodiments illustrated in FIGS. 6B and 6C also are valid for embodiments where, the NAT 5-7 illustrated in these figures was replaced by some intermediate network node, for example a home gateway, a router, or a home gateway containing a router, such intermediate network node containing the NAT 5-7.

Still in other embodiments (not illustrated in FIGS. 6A-6C), the NAT-type ID may be attached to the request somewhere else along the path between the EUD 3 and the NIP 2. For example, a network node such as a DSLAM or a router, situated between the NAT 5-7 and the NIP 2, may attach the NAT-type ID to the request. Such network node may even be situated in the home network between the EUD 3 and the NAT 5-7. In all these situations, these network nodes may also serve as a proxy for the requests sent by EUD 3 to the NIP 2.

As long as the NAT-type ID is provided to the NIP 2 via some intermediate network node, either as a part of a request for NAT-related information for NATs of a particular NAT type or without such an explicit request, the intermediate network node may be configured to supplement the message with additional information that could be useful for the NIP 2, such as for example the status of the network, expressed in terms of e.g. the network load to that specific NAT. The intermediate network node may also be configured to reformat the message if the EUD 3 and the NIP 2 do not use the same protocol, for example to reformat between different versions of the same protocol. Further, the intermediate network node may be configured to confirm the NAT-type ID that is sent in the message is correct. This could be useful in situations where the EUD 3, or a client on the EUD 3, is not ‘trusted’ and the intermediate network node is. For all of the different manners of providing the NAT-type ID to the NIP 2, the NIP 2 could respond to a request for NAT-related information by providing to the EUD 3, from the database 8, the NAT-related information for the NAT-type identified by the NAT-type ID, which could either be used by the EUD 3 upon receipt or be stored in the EUD 3 for later use. In the embodiment illustrated in FIG. 6C, the NIP 2 could provide the NAT-related information to the EUD 3 via the NAT 5-7, or an intermediate network node containing the NAT 5-7, directly to the EUD 3, in other words by skipping the NAT 5-7 or an intermediate network node containing the NAT 5-7. Alternatively, the NIP 2 could provide the NAT-related information to the EUD 3 via some other intermediate network node that is not shown in FIG. 6C. In the embodiments where the NAT-related information is provided by the NIP 2 to the EUD 3 via some intermediate network node, for example the NAT 5-7, a network node containing the NAT 5-7 or some other network node not containing the NAT 5-7, the intermediate network node may be configured to supplement the response with additional information that could be useful for the EUD 3, such as for example the status of the network or to reformat the message if the EUD 3 or a client on the EUD 3 and the NIP 2 do not use the same protocol. Alternatively or additionally, the intermediate network node may be configured to proxy the response message, for example if the intermediate network node also proxied the initial request.

While the examples illustrated in FIGS. 6A-6C are explained above in the context of the NIP 2 receiving a request for NAT-related information, the various manners of providing the NAT-type ID to the NIP 2 as described in association with FIGS. 6A-6C are also valid for the embodiments where the NAT-type ID is provided without an explicit request for NAT-related information. In such embodiments, the NIP 2 could provide the NAT-related information when the NIP 2 is triggered with some other trigger, as long as the NIP 2 has access to NAT-type ID for that EUD, obtained e.g. in one of the manners illustrated in FIGS. 6A-6C, and as long as the EUD 3 is configured to listen to the messages from the NIP 2. The trigger in the example above could be e.g. expiration of a particular time period when the NIP 2 is configured to provide the NAT-related information periodically, the EUD 3 booting up, the EUD 3 being con-connected to the local network, or some other change taking place in the network. Also, the NIP 2 could be configured to provide NAT-related information to the EUD 3 as a response to a more general request from the EUD 3, such as for example a general configuration request. This may e.g. be the case when the NIP 2 is part of an Automatic Configuration Server (ACS), not shown in FIGS. 6A-6C, also providing other non-NAT related configuration information to the EUD 3. The EUD 3 may not be aware that the ACS is able to provide NAT-related information, but may receive it as a response to a non-NAT related configuration request.

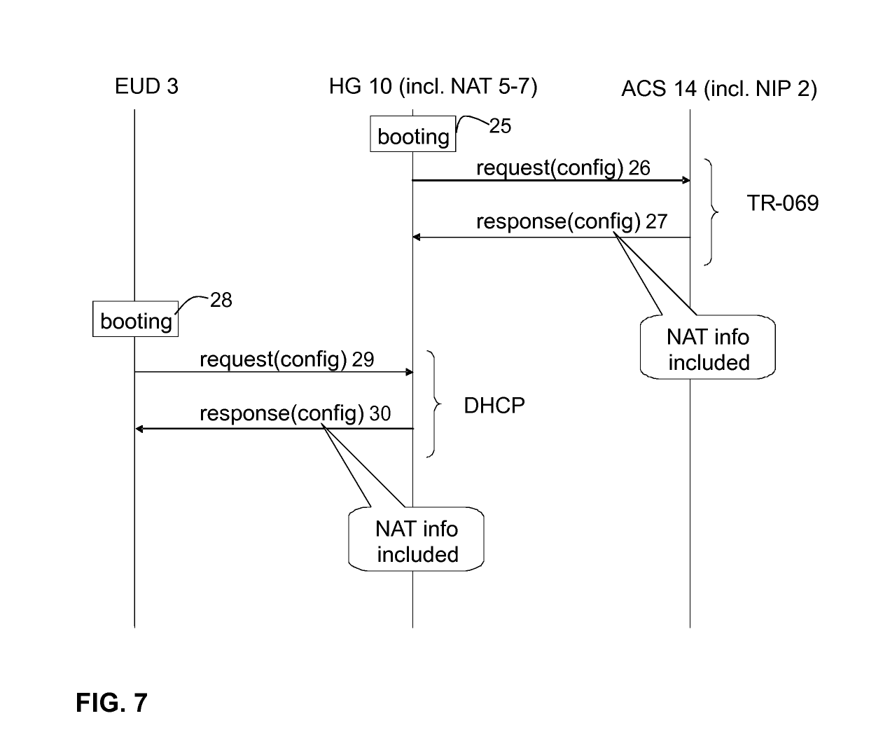

FIG. 7 is a schematic illustration of an exemplary setting in which the NIP 2 could provide NAT-related information to the EUD 3, according to one embodiment of the invention. As shown in FIG. 7, the NAT could be included within a Home Gateway (HG) 10 and the NIP 2 could be a part of an ACS 14. The HG 10 could be, for example, a router or a home gateway containing a router as well as containing additional functionality. After booting (step 25), the HG 10 would request configuration from the ACS 14 using e.g. TR-069 (step 26). Part of this configuration request could be used to get additional information to be used later in DHCP responses to the EUD 3. Since the HG 10 is providing the request to the ACS 14, the ACS 14 is aware of the identity of the NAT type of the NAT 5-7 in the HG 10, and can provide the NAT-related information for the identified NAT type (step 27). The HG 10 does not need to understand the NAT-related information received from the ACS 14, as the HG 10 could be configured to merely immediately pass the information to the EUD or to store the information to provide it to EUDs later on.

As further shown in FIG. 7, on booting (step 28), the EUD 3 could use DHCP to request configuration from the HG 10 (step 29). In various embodiments, IP address information, default gateway, and DNS server addresses could be the primary information provided by the EUD 3 via DHCP, but more information can be contained in DHCP responses. In this case, the HG 10 would include the NAT-related information in its response (step 30). In this manner, the HG 10 acts as a proxy for the NIP 2 storing the NAT-related information appropriate for the EUD 3 (i.e., the NAT-related information for NATs of a particular NAT type that the EUD 3 is behind) and providing the information to the EUD 3 at some later point, possibly in response to a request from the EUD 3 to do so.

FIG. 7 could be considered to be a special case of the embodiment illustrated in FIG. 6C. Therefore, all of the discussions provided herein with respect to FIG. 6C, including those regarding possible variations in FIG. 6C, are applicable to FIG. 7. In the interests of brevity, those discussions are not repeated here.

FIGS. 8A and 8B set forth flow diagrams of method steps of the NIP 2 collecting NAT-related information, according to various embodiments of the present invention. While the method steps are described in conjunction with FIGS. 1 and 2, persons skilled in the art will recognize that any system configured to perform the method steps, in any order, is within the scope of the present invention.

FIG. 8A illustrates a basic flow for the NIP 2. The method begins in step 31, where the NIP 2 determines the need for NAT-related information. For example, in one embodiment, the NIP 2 can determine that the NAT-related information is needed for a particular NAT type if the NIP 2 does not have any or has only incomplete NAT-related information for that NAT type. In another embodiment, the external network can detect the presence of new gateway devices, the new gateway devices being new NATs and/or including new NATs, and indicate to the NIP 2 that there are possible new NATs for which NAT-related information should be determined. In yet another embodiment, the NIP 2 may receive a request for NAT-related information that the NIP 2 cannot fulfil and, consequently, determine that additional NAT-related information should be acquired. The NIP 2 could also be configured to try and collect NAT-related information from certain IP ranges, without knowing in advance whether these IP addresses are in use by NATs. The NATs or EUDs in their LANs may also be configured to indicate to the NIP 2 their capabilities to provide to the NIP 2 NAT-related information, including an identification of their respective NATs.

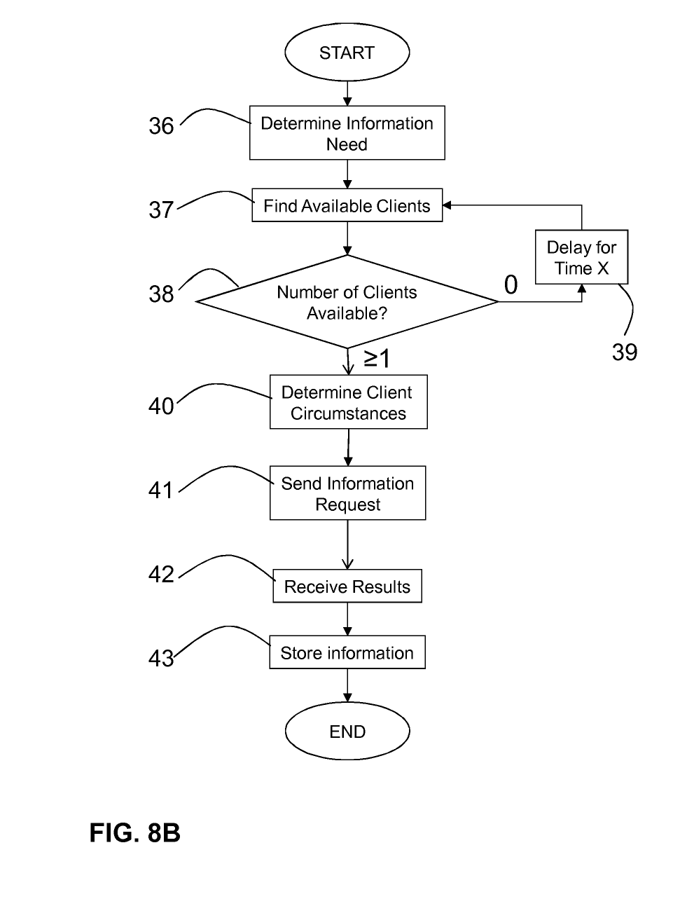

The method then proceeds to step 32, where the NIP 2 may send a request, either explicitly or implicitly, for NAT-related information to a STUN client. The functionality of the STUN client is described in greater detail in association with FIGS. 9-14B below.

In step 33, the STUN client performs NAT behaviour detection and provides the results of this detection to the NIP 2 as a response to the request for NAT-related information (step 34). The method ends in step 35, where the NIP 2 stores the received NAT-related information in the database 8 in such a way, that the NIP 2 can retrieve this information based on the NAT-type IDNAT-type ID.

NATs may behave differently in different circumstances, depending e.g. on the amount of memory and processing usable for NAT purposes and, therefore, depending on the amounts used by other processes or applications on the device. NATs may also behave differently depending on the network load and/or the number of active sessions. Therefore, it may be advantageous to implement multiple STUN clients each supplying a part of the NAT-related information for a particular NAT type and/or implement one or more STUN clients that may supply a part of the NAT-related information at one point in time and supply additional NAT-related information at another point in time. FIG. 8B shows a more complex flow for collecting NAT behaviour information for a certain NAT type according to such embodiments.

As shown in FIG. 8B, the method begins, in step 36, with the NIP 2 determining the need for NAT-related information, similar to step 31, described above. However, in step 36, the NIP 2 may be configured to not only determine on which NAT types the NIP 2 does not have NAT-related information, but also determine on which NAT types it has partial information. Additionally or alternatively, the NIP 2 may be configured to determine that it has no need for complete NAT-related information on a certain NAT type, either at the moment or at all, but only has a need for partial NAT-related information. This could be the case if there is or is expected to be a request for partial NAT-related information, e.g. for NAT behaviour information in specific circumstances.

After determining the need for NAT-related information and the type of the information needed, the NIP 2 finds available STUN clients (step 37). In one embodiment, the NIP 2 may already know of certain STUN clients being able to provide particular information on certain NAT types. The NIP 2 may also interact with network management systems to acquire this information and/or may be configured to find available STUN clients through trial and error, e.g. by trying certain IP address ranges.

If, in step 37, the NIP 2 cannot find any STUN clients available, it can delay for a certain amount of time and try again later, as shown in FIG. 8B with steps 38 and 39. Such an embodiment may be advantageous because both NATs and STUN clients may come and go, i.e. become connected and disconnected from the networks over time.

When the NIP 2 does find one or more available STUN clients, the NIP 2 then determines their circumstances (step 40). When the NIP 2 needs only partial NAT-related information requiring specific circumstances, e.g. specific network load or number of simultaneous sessions, one or more NATs in those specific circumstances need to be identified. To determine these circumstances, the NIP 2 may request the circumstances from the NATs themselves and/or from a monitoring function in either the LAN or the WAN. After identifying the STUN clients that can provide the information needed, the method proceeds to step 41 where the NIP 2 sends one or more requests for specific NAT-related information to the one or more STUN clients identified in step 40. In step 42, the NIP 2 receives the requested information from the STUN clients. The method ends in step 43, where the NIP 2 stores the received NAT-related information in the database 8.

FIG. 9 is a schematic illustration of the NIP 2 obtaining NAT-related information using STUN protocol, according to one embodiment of the present invention. While embodiments described herein refer to the STUN protocol as specified in IETF RFC 5389, these embodiments could also be implemented, with appropriate modifications which would be apparent to a person skilled in the art, using a similar, possibly non-standardized protocol. In other words, while FIGS. 8A-14B are described with reference to a STUN client and a STUN server, analogous teaching may be derived for any client and any server configured to exchange one or more messages for the purpose of determining NAT-related information in accordance with some protocol other than the STUN protocol. A person skilled in the art would recognize that the terms “any client” and “any server” in this context could refer to appropriately configured pieces of software on devices.

The description of a STUN client obtaining NAT-related information to provide to the NIP 2 provided in association with FIG. 9 can e.g. be applied to the STUN clients discussed in FIGS. 8A and 8B.

As shown in FIG. 9, in step 47 the NIP 2 may send a request for NAT-related information to a STUN client (SC) 45. If the STUN client 45 does not have the NAT-related information available already, the STUN client 45 may have to determine the requested information, which may be done by exchanging a number of STUN messages with a STUN server (SS) 46 (step 48). As also shown in FIG. 9, in the final step 49, the STUN client 45 sends a message to the NIP 2 containing the requested NAT-related information.

In one embodiment, the STUN Client 45 could be implemented on an EUD at one side of a NAT, while the STUN Server 46 could be implemented on a server on the other side of the NAT, where the NAT could be one of the NATs 5-7 described herein. In one particular embodiment, the STUN Client 45 could be implemented on an EUD such as one of the EUDs 3 described herein on the LAN side of a NAT while the STUN Server 46 could be implemented on a server on the WAN side of the NAT. However, other embodiments are described below where the STUN client 45 and/or the STUN server 46 may be implemented differently.

The nature of the specific messages and the number of messages exchanged between the STUN client 45 and the STUN server 46 in step 48 are dependent on the nature of the NAT-related information that is to be determined. As discussed above, the STUN client 45 could be configured to de-liver partial information, e.g. if not all of the requested information could be determined and/or if only partial information is requested from a particular STUN client 45 at a particular point in time.

The embodiment illustrated in FIG. 9 assumes that the NIP 2 actively sends a request for NAT-related information, as illustrated with step 47 shown in FIG. 9. However, step 47 is optional in that the discussions provided in association with FIG. 9 can also be applied for the embodiments where the STUN client 45 would be configured to provide NAT-related information to the NIP 2 without the NIP 2 sending an explicit request for such information. The STUN client 45 could be configured to provide information to the NIP 2 possibly in response to some other trigger. For example, the information can be provided from the STUN client 45 to the NIP 2 at particular predetermined times, upon expiration of a predetermined time interval, at the boot-up of the STUN client and/or the EUD, when an EUD is being connected to the LAN, or when something changes in the LAN. Such triggers for providing NAT-related information from the STUN client 45 to the NIP 2 are similar to the triggers that may be used for the NIP 2 to provide the NAT-related information to the EUDs 3.

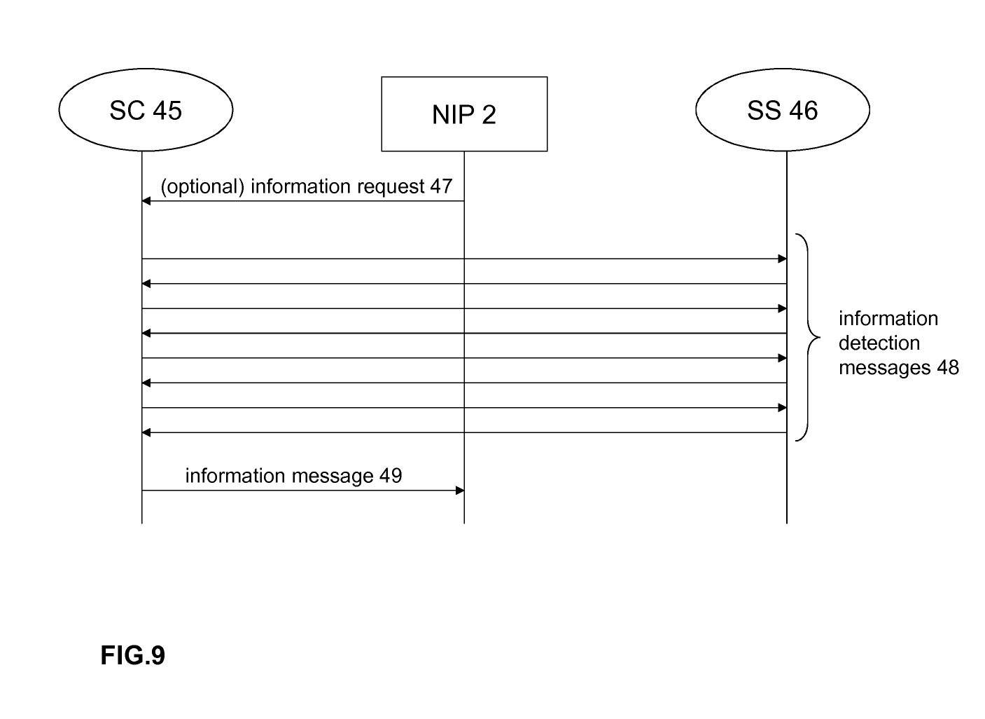

Regardless of whether or not step 47 is present in the process of the NIP 2 obtaining NAT-related information from the STUN client 45, the STUN client 45 should be “behind” the NAT in that the messages exchanged between the STUN client 45 and the STUN server 46 in step 48 described above should go through the NAT in the proper direction, in order to be able to obtain NAT-related information. For the embodiments where step 47 is present, a further requirement would also be that the STUN client 45 should be able to receive requests from the NIP 2 for NAT-related information. FIGS. 10, 11, 12A-12B, and 14A-14B provide schematic illustrations of different manners for deploying a STUN client that satisfies these requirements, according to various embodiments of the present invention. The NATs illustrated in these figures could be any one of NATs 5-7, described herein.

FIG. 10 illustrates that the STUN client 45 may be implemented as a part of or an addition to one or more of the EUDs 3 in the LAN. While such a setup would meet the first requirement in that the STUN client 45 would be behind the NAT 50, the second requirement would not normally be satisfied because requests from the NIP 2 from the WAN side of the NAT 50 will not normally pass through the NAT 50 and, therefore, will not reach the STUN client 45. To satisfy the second requirement, in one embodiment, the NAT 50 may be configured to contain a virtual server rule to allow requests from the NIP 2 to pass through the NAT 50 to the EUD 3. In another embodiment, the EUD 3 may include two or more interfaces, where at least one of the interfaces would be behind the NAT 50 and at least one other interface is not. In yet other embodiments, the EUD 3 may be configured to initiate a connection to the NIP 2, e.g. after booting, so that later the NIP 2 can traverse the NAT 50 to reach the EUD 3.

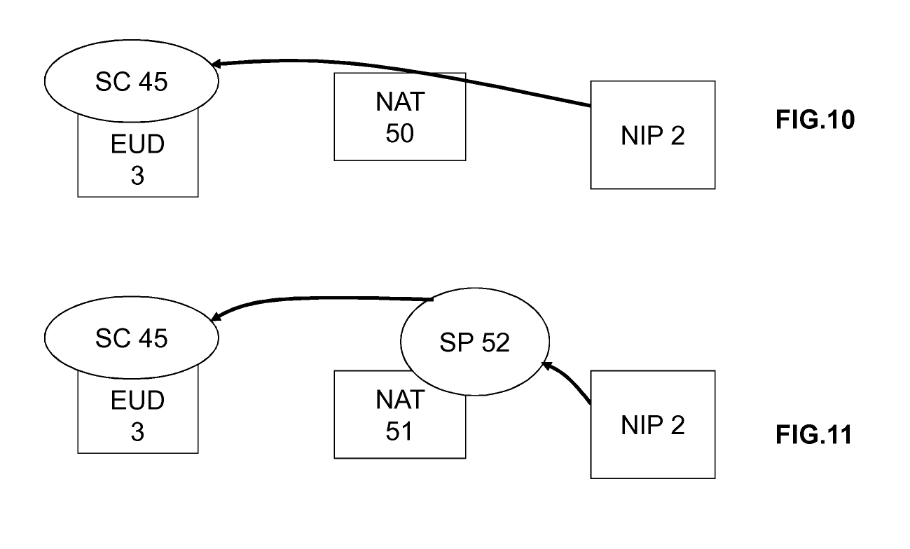

FIG. 11 illustrates another setup, where, similar to FIG. 10, the STUN client 45 is implemented as a part of or an addition to one or more of the EUDs 3 in the LAN. In order to satisfy the second requirement, a NAT 51 contains a service proxy (SP) 52. The service proxy 52 allows a request from the NIP 2 to go to the NAT 51, and then the NAT 51 forwards this request to the EUD 3. An example of such implementation could be remote access to UPnP services in a LAN. The NAT 51, e.g. a home gateway and/or router, may support such type of remote access, and the STUN client 45 could be implemented as an UPnP service on the EUD 3.

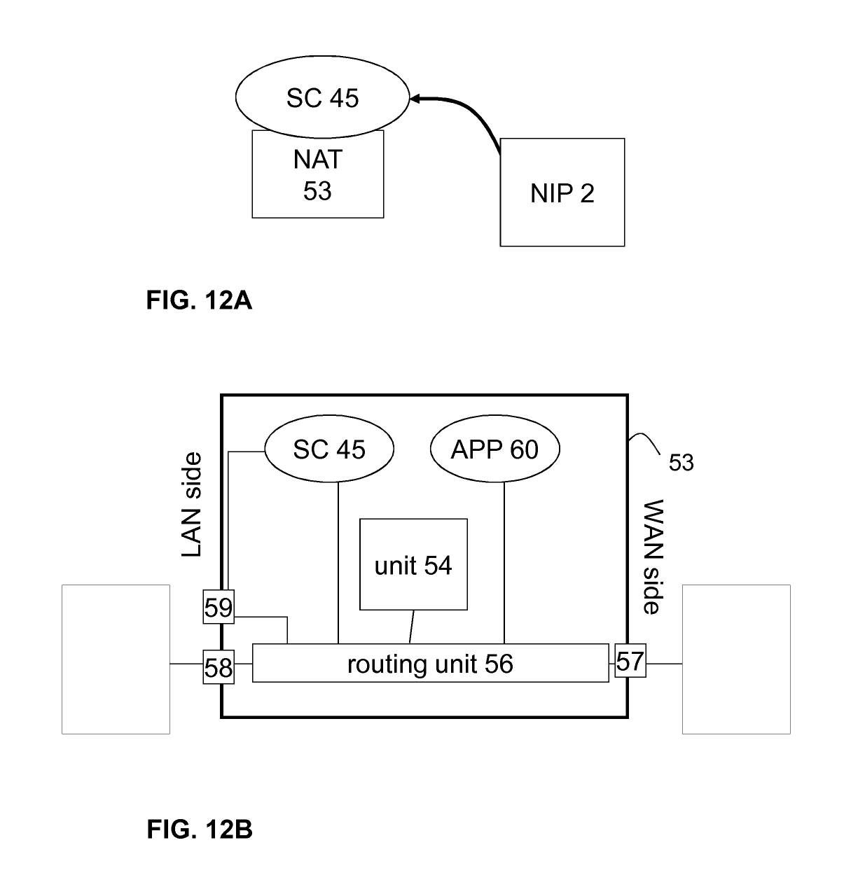

FIG. 12A illustrates a third set-up for deploying the STUN client 45. In a set-up as shown in FIG. 12A the messages from the NIP 2 can reach the STUN client 45 because the STUN client 45 is implemented as a part of a NAT 53. However, with such implementation, unless additional measures are taken as described below, the first requirement for the STUN client 45 is not met because the STUN client 45 would not be behind the NAT 53.

FIG. 12B is a schematic illustration of the NAT 53 illustrated in FIG. 12A capable of satisfying the requirements for having a STUN client functionality, according to one embodiment of the present invention. FIG. 12B illustrates that the NAT 53 comprises the STUN client 45, a NAT unit 54 configured to actually performs the functionality of a NAT within the NAT 53 and, optionally, one or more of applications 60 such as e.g. VoIP applications, VPN applications, storage applications, IPTV applications, security applications, home automation applications, and management applications in the form of, for example, a web interface on the device. As also shown in FIG. 12B, the NAT 53 includes an interface 57 to the WAN and an interface 58 to the LAN. As also shown, the NAT 53 comprises a routing function 56 configured for routing IP packets.

The NAT unit 54 is configured for applying network address translation to traffic, via the routing function 56, the traffic coming from the LAN, via the interface 58, and going to the WAN, via the interface 57, and vice versa. In addition, the NAT 53 comprises a virtual network interface 59 for the STUN client 45, on the LAN side of the NAT 53. The virtual network interface 59 behaves like a regular network interface to the routing function 56, i.e. the virtual network interface 59 allows sending and receiving IP packets and has an IP address assigned to it. However, instead of being a driver for a piece of hardware such as a network interface card, the virtual network interface 59 is a driver which delivers the network traffic to a specific software application, in this case the STUN client 45.

The virtual network interface 59 should be configured as any other interface. To enable proper NAT testing, both the interface 59 and the routing rules could be configured similar to the LAN interface 58 or multiple LAN interfaces, to make packets travel the correct route through the NAT unit 54. The interface 59 could also be configured to e.g. form a bridge group with the hardware interface on the LAN side (i.e., the interface 58), in which case both the virtual network interface 59 and the interface 58 will use the same routing configuration, and thus packets will travel the correct way.

The routing function 56 is configured to route messages exchanged between the STUN client 45 within the NAT 53 and a STUN server somewhere outside of the NAT 53, possibly in a WAN, so that the messages traverse the NAT unit 54. Such configuration ensures that the STUN client 45 is “behind” the NAT in the network sense since, in a similar way as if the STUN client 45 was implemented on an EUD connected to the LAN side of the NAT, the messages exchanged between the STUN client 45 and the STUN server 46 are routed via the NAT unit 54.

In various embodiments, the routing function 56 could be implemented in hardware, software, firmware, or any combination of two or more of these.

In the implementation of FIG. 12B, further measures may be implemented to ensure that the STUN client 45 is reachable by the NIP 2, similar to the examples described in association with FIGS. 10 and 11. In the interests of brevity, those descriptions are not repeated here.

In one embodiment, the Linux Tun or Tap implementations, currently used for creating Virtual Private Network (VPN) connections, could be used to implement the virtual network interface 59. In other embodiments, some other virtual network interface implementation could also be used to implement the virtual network interface 59, as long as the routing configuration is programmed in such a way, that the virtual network interface 59 is on the LAN side of the NAT 53, as described in FIG. 12B.

Implementing the STUN client 45 on the NAT 53 or on any network node having NAT functionality, as opposed to implementing the client on the EUD 3 in a local network behind such a NAT or such a network node, allows messages sent by the NIP 2 to reach the STUN client 45, while the routing unit 56 ensures that the STUN client 45 is “behind” the NAT in the network sense. In this manner, the NIP 2 may request NAT behaviour discovery and obtain NAT-related information from the STUN client 45. After that, the NIP 2 is able to provide appropriate NAT-related information to terminals in local networks, the provided NAT-related information enabling the terminals to traverse the NATs that they are behind.

In addition, implementing the STUN client 45 on the NAT 53 or on a similar network node having NAT functionality eliminates the need to have a terminal behind the NAT 53 that is available for NAT behaviour discovery. This means that as soon as the NAT 53 is available, meaning that the Nat 53 is “online,” switched on and connected, testing of the NAT may be immediately carried out.

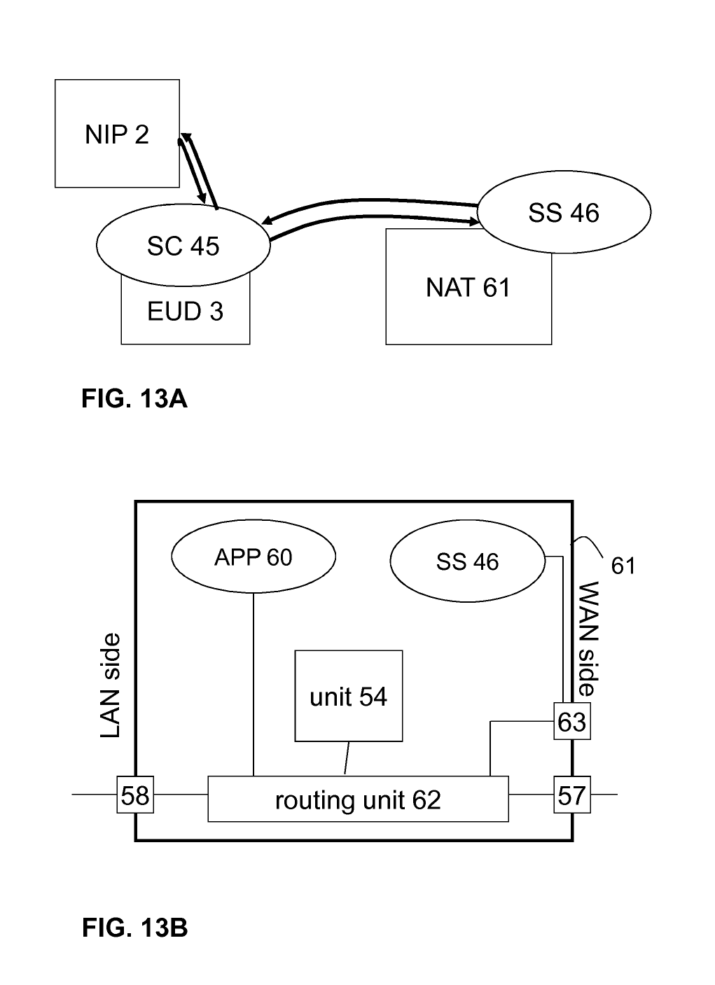

Similar to the implementation of the STUN Client 45 on the NAT itself, as described above, the STUN Server 46 may also be implemented on the NAT. FIG. 13A provides a schematic illustration of deploying the STUN server 46 as a part of a NAT 61, according to one embodiment of the present invention. The NAT 61 could be any one of NATs 5-7, described herein.

One advantage of such implementation is eliminating the need of having the STUN server 46 in the WAN. Including the STUN Server 46 in the NAT 61 allows faster determination of the NAT-related information using the STUN protocol because no STUN messages have to travel the WAN side of the network. In addition, the NAT 61 may even be tested without requiring an actual connection on the WAN part of the NAT 61.

Yet further, such a solution is scalable because each NAT may contain a STUN server for use for EUDs in the LAN that is connected to the NAT. The idea of implementing the STUN server 46 on a NAT is based on a recognition that a single network node, such as e.g. a NAT or a homegate including a NAT, typically has enough processing power to deal with NAT behaviour discovery for the relatively few EUDs that are in the LAN behind such network node. Thus, the implementation of the STUN server 46 on the NAT eliminates the need to for a central server, such as a STUN server, with sufficient capacity to service many individual terminals.

FIG. 13B provides a schematic illustration of the NAT 61 capable of implementing STUN server functionality as shown in FIG. 13A, according to one embodiment of the present invention. FIG. 13B illustrates the same basic elements as those of FIG. 12B, such as e.g. the NAT unit 54, the application 60, the LAN interface 58 and the WAN interface 57. In the interests of brevity, the description of these elements is not repeated here.

As also shown in FIG. 13B, the NAT 61 further includes the STUN server 46, a routing function 62, and an interface 63. Similar to the virtual network interface 59 shown in FIG. 12 A, the interface 63 is also a virtual network interface, but on the WAN side of the NAT 61. The virtual network interface 63 includes similar functionality as the interface 59 and is configured in a manner similar to how the interface 59 for the STUN client 45 shown in FIG. 12B is configured, except that no further measures are necessary to make the STUN server 46 reachable. A STUN server is normally only sent messages by a STUN client through a NAT, and does not require an additional interface or virtual server rule for making the STUN server accessible for other functions. A STUN server may of course have an interface for e.g. remote management of the STUN server itself.

To use a virtual network interface on the WAN side of the NAT, an address has to be assigned. This address will typically be a public address, routable in the external network, because these are the addresses used on the WAN side of the NAT. Such public addresses are typically unique because of the routing purpose in the WAN, and are normally assigned only once, i.e. to a single device, at the same time. But, since in the embodiment shown in FIG. 13B, the traffic is routed through the NAT unit 54 to this address, i.e. does not leave the node 61 containing the NAT unit 54, the same public address can be used for different implementations of the NAT at the same time. Note also that since the traffic to the STUN server 46 on the NAT 61 does not go through the external network, the address assigned to the STUN server 46 does not have to be a public address. The address can also be a private address, i.e. normally used on the LAN side of the NAT, if the NAT 61 can be configured in such a way that traffic originating from the LAN side of the NAT 61 and destined to such a private address of STUN server on the WAN side of the NAT will indeed go through the NAT unit 54.

Assigning the same public address to the STUN server in various NATs can also be combined with actually assigning this same public address to a STUN server in an external network. STUN clients can then receive this address of the STUN server in their configuration. If the NAT they are behind has implemented a STUN server as shown in FIG. 13B, their STUN requests will be then routed to that STUN server. If the NAT they are behind has not implemented a STUN server in this way, their requests will be automatically be routed to the STUN server in the external network.

To one skilled in the art, it will be obvious that to use such a virtual network interface, the routing rules will have to be configured accordingly. This can be done in various ways, such as creating a bridge group containing the virtual network interface and the actual network interface, or by configuring the routing tables for this specific purpose.

Similar to the routing function 56, the routing function 62 is configured to route messages exchanged between the STUN server 46 within the NAT 61 and the STUN client 45 somewhere else (but within the LAN, so that the STUN client 45 is behind the NAT 61) so that the messages traverse the NAT unit 54.

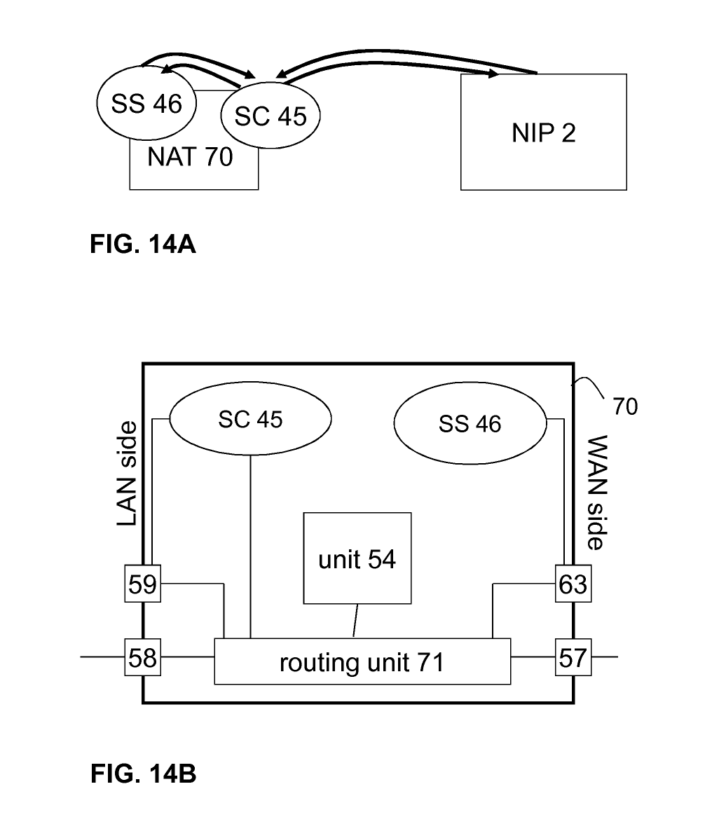

In yet another embodiment, both a STUN client and a STUN server may both be implemented on the NAT. This is shown in FIG. 14A providing a schematic illustration of deploying both the STUN client 45 and the STUN server 46 as part of a NAT 70, according to one embodiment of the present invention. FIG. 14B provides a schematic illustration of the NAT 70 capable of implementing STUN client and STUN server functionalities as shown in FIG. 14A, according to one embodiment of the present invention. As shown e.g. with the virtual network interfaces 59 and 63, FIG. 14B is a combination of FIG. 12B and FIG. 13B. If the STUN client 45 needs to be reachable from the WAN side of the NAT 70, it will still require e.g. a virtual server rule. If both the STUN client 45 and the STUN server 46 are implemented on the same NAT, using such virtual network interfaces, STUN behaviour discovery can be very fast because no STUN messages have to actually travel the network. Also, discovery can still be done without any connection available, or if connections are available, they are not burdened with network traffic for NAT discovery, saving the network resources for other purposes.

Even though FIGS. 12A-12B, 13A-13B, and 14A-14B were described as depicting the NAT 53, the NAT 61 and the NAT 70, respectively, in other embodiments the devices 53, 61, and 70 could be not NATs “per say,” but any intermediate network nodes comprising NAT functionality, such as e.g. home gateways, routers, or home gateways comprising routers. In such devices, the NAT functionality would be implemented via the NAT unit 54. In addition, each of the devices 53, 61, and 70 could further, optionally, include at least a memory for storing data and computer programs, a processor for running computer programs on and for processing data, and a communications module for sending and receiving messages/data traffic. For example, the functionality of the routing functions 56, 63, and 71 could be implemented as a computer program stored in the memory for being run on a processor.

Furthermore, the functionality of the NATs 53, 61, and 70 was described with reference to and in the context of the NIP 2 storing and distributing the NAT-related information on a per-type basis, at least for some NATs. However, in other embodiments, the NAT behaviour discovery using the NAT 53, 61, and 70 as illustrated in FIGS. 12A-B, 13A-B, and 14A-B, respectively, may be employed by any NAT information provider, such as e.g. a conventional NAT information provider configured to store and distribute NAT-related information on a per-device basis.

The following discussions apply to all of the embodiments described herein.

In various embodiments, the STUN client 45 may be a part of an application or may be a part of a web page. For example, the STUN client 45 may be implemented as a plug-in for Internet applications, for example a browser or an instant messaging application, or as a piece of Java script on a webpage. Each time a user would use an EUD to browse a certain web page, such a piece of Java script could be downloaded and ran. This could be done in the foreground, e.g. a web page may be specially created for the purpose of detecting NAT-related information, e.g. a web page of an operator hosting the NIP 2. Alternatively, the Java script may also be part of other web pages and run in the background, without users awareness that the script is running.

In further embodiments, instead of only monitoring the circumstances and reporting on the circumstances during which NAT-related information was determined, the STUN client 45 may be configured to actively affect these circumstances. For example, the STUN client 45 may be configured to set up multiple sessions or cause additional network load to be able to determine NAT behaviour during circumstances of multiple sessions or heavy network load.

The embodiments described herein mainly deal with using an existing STUN client to determine the NAT-related information of a NAT that the STUN client is behind in the circumstances present at the moment of determination. However, a STUN client similar to the STUN client 45 may also be deployed on demand. Such a STUN client may e.g. be deployed on an EUD or NAT using TR-069, using OSGii framework, or using some other means for transporting the STUN client software to the NAT and installing it on the NAT. Implementing a STUN client on demand may provide the advantage that the STUN client would e.g. only take up resources at night when a NAT is not used by the end users or during other times of low usage. Such a STUN client may be removed once the NAT and/or the EUD is used again for other purposes, or can remain implemented but become inactive until another idle period.

Further, there are various other offline means through which the NIP 2 may obtain NAT-related information, possibly in addition to the means described above. In one example, a manufacturer of a NAT could supply this information. In another example, a NAT could be tested in a test environment in which various kinds of circumstances can be simulated or replicated. This could be done by using STUN protocol, but could also be done using network sniffers on both ends of the NAT and then testing a variety of messages going through the NAT from and to different IP addresses and ports. In yet another example, the NAT behaviour could be deduced through the analysis of the actual code of the implementation of the NAT. This code can either be available, e.g. because it is open source or is supplied by the manufacturer, or can be retrieved through reverse engineering of the NAT. The NAT behaviour of a specific device type can also be deduced if that device type uses the same NAT implementation as some other specific device types, e.g. if it is based on the same Linux iptables versions and uses the same configuration.

In various embodiments, each of the NATs 5-7, the STUN client 45, and/or the STUN server 46 can be implemented in software, hardware, firmware or any combination of two or more of these.

The NIP 2 described herein is described as a single entity. In practice, often for the purpose of scalability, the NIP 2 may be implemented as two or more various entities configured to work together, e.g. in a distributed fashion. This can e.g. be done by having multiple entities each serving a number of end devices, by having a virtualization layer on top of multiple physical entities and having the NIP on top of that, i.e. the NIP as a ‘cloud services’, by having a load sharing or load distribution mechanism in place, and so on.

One embodiment of the invention may be implemented as a program product for use with a computer system. The program(s) of the program product define functions of the embodiments (including the methods described herein) and can be contained on a variety of, preferably non-transitory, computer-readable storage media. Illustrative computer-readable storage media include, but are not limited to: (i) non-writable storage media (e.g., read-only memory devices within a computer such as CD-ROM disks readable by a CD-ROM drive, ROM chips or any type of solid-state non-volatile semiconductor memory) on which information is permanently stored; and (ii) writable storage media (e.g., floppy disks within a diskette drive or hard-disk drive or any type of solid-state random-access semiconductor memory, flash memory) on which alterable information is stored. The computer program may be run on the processing units described herein.

The invention claimed is:

1-15. (canceled)

16. A network node comprising:
a network address translator (NAT);
a client configured to determine NAT-related information for the NAT by exchanging one or more messages with a server; and
a routing unit configured to route the one or more messages exchanged between the client and the server via the NAT.

17. The network node of claim 16, further comprising a communications module configured to provide the determined NAT-related information for the NAT to a NAT-information provider (NIP).

18. The network node of claim 17, wherein the NAT-related information is determined in response to receiving a request for determining the NAT-related information from the NIP.

19. The network node of claim 16, wherein the NAT-related information is determined based, at least partially, on a trigger indicating a predetermined time, expiration of a predetermined time interval, a boot-up procedure of the network node, the network node being connected to a local network, the network node being connected to an external network, the network node receiving an indication regarding a change in the local network, and/or the network node receiving an indication regarding a change in the external network.

20. The network node of claim 16, wherein the NAT-related information includes at least one of:
current ports in use by the NAT unit;
current Wide Area Network Internet Protocol address of the NAT;
current virtual server rules for the NAT;
port mapping behaviour of the NAT;
filtering behaviour of the NAT;
support for hairpinning by the NAT;
one or more of port allocation algorithms implemented in the NAT;
timeout value for NAT binding in the NAT; or
behaviour of the NAT during congestion, during heavy network traffic, during multiple simultaneous sessions and/or during multiple simultaneous NAT bindings.

21. The network node of claim 16, wherein the server is included within the network node.

22. The network node of claim 16, wherein the one or more messages are routed using a virtual network interface configured to pass the one or more messages via the NAT.

23. The network node of claim 22, wherein the virtual network interface is a part of a bridge group.

24. The network node of claim 16, wherein the one or more messages are exchanged according to a STUN protocol.

25. The network node of claim 16, wherein the network node comprises a home gateway and/or a router.

26. A computer program comprising software code portion configured, when executed by a processor in a network node comprising at least a network address translator (NAT) and a client adapted for determining NAT-related information for the NAT by exchanging one or more messages with a server, for routing the one or more messages exchanged between the client and the server via the NAT.

27. A NAT-information provider for use with the network node according to claim 16, wherein the NAT-information provider is configured to:
receive, from the network node, the NAT-related information; and
store the NAT-related information in a database, wherein the NAT-related information is stored associated with an identification of a NAT type of the NAT included in the network node.

28. The NAT-information provider of claim 27, wherein the NAT-information provider is further configured to provide a request to the network node to determine the NAT-related information for the NAT included in the network node.

29. The NAT-information provider of claim 27, wherein the NAT-information provider is further configured to:
receive, from a first device in a first local network, a request for NAT-related information for NATs of the same NAT type as the NAT type of the NAT included in the network node; and
select the NAT-related information from the database based on the identification of the NAT type and provide the selected NAT-related information to the first device.

30. The NAT-information provider of claim 29, wherein the NAT-information provider is further configured to:
receive, from a second device in a second local network, a request for NAT-related information for NATs of the same NAT type as the NAT type of the NAT included in the network node; and
select the NAT-related information from the database based on the identification of the NAT type and provide the selected NAT-related information to the second device.
